(19) United States
(12) Patent Application Publication
(10) Pub. No.: US 2024/0005719 A1
(43) Pub. Date: Jan. 4, 2024

(54) DISTRIBUTED BIOMETRIC IDENTITY SYSTEM ENROLLMENT WITH LIVE CONFIRMATION

(71) Applicant: Alclear, LLC, New York, NY (US)

(72) Inventors: Sam Hall, New York, NY (US); Kenneth Cornick, New York, NY (US)

(21) Appl. No.: 17/856,964

(22) Filed: Jul. 2, 2022

(51) Int. Cl. G07C 9/37; G06F 21/32; G07C 9/26

(52) U.S. Cl. CPC G07C 9/37; G06F 21/32; G06F 2221/2103; G06F 2221/2117; G07C 9/26

(57) ABSTRACT

A biometric identity system performs enrollment with live confirmation. Biographic and/or other identity information may be obtained for a person via one or more first electronic devices. Biometric data may also be obtained for the person via the one or more first electronic devices. The biographic and/or other identity information may be used to verify the identity of the person. The person may then be enrolled in a biometric identity system, but a record for the person may be noted as unconfirmed and/or otherwise needing confirmation. Subsequently, one or more digital representations of one or more biometrics and/or other identifiers may be received for the person via one or more second electronic devices. The person may be identified and, in response, one or more confirmation processes may be initiated (such as requesting confirmation from a live agent) and the record for the person may be updated.

### FIELD

The described embodiments relate generally to biometric identification. More particularly, the present embodiments relate to distributed biometric identity system enrollment with live confirmation.

### BACKGROUND

Various electronic devices may use identity information for people to perform a number of different actions. Identity information may include a name, an address, entitlements (such as purchased tickets), financial information, and/or any other information associated with a person's identity. For example, a security station may access identity information to determine a person's name as part of screening the person for entry into a secured area, such as an airport, an event venue, and so on. Such electronic devices may protect the identity information to restrict access to and/or use of the identity information. For example, an electronic device may require login to an account associated with the identity information prior to taking any action that accesses and/or otherwise uses the identity information.

Various mechanisms may be used to determine a person's identity in order to access associated stored identity information. For example, a biometric identity system may identify a person by comparing one or more digital representations of biometrics for the person to stored biometric data for a number of people that is associated with identity information for those people. The biometric data may include one or more digital representations of one or more fingerprints, blood vessel scans, palm-vein scans, voiceprints, facial images, retina images, iris images, deoxyribonucleic acid sequences, heart rhythms, gaits, and so on. The person may be enrolled in the biometric identity system prior to the biometric identity system being used to biometrically identify that person.

### SUMMARY

The present disclosure relates to distributed biometric identity system enrollment with live confirmation. Biographic and/or other identity information may be obtained for a person via one or more first electronic devices. Biometric data may also be obtained for the person via the one or more first electronic devices. The biographic and/or other identity information may be used to verify the identity of the person. The person may then be enrolled in a biometric identity system, but a record for the person may be noted as unconfirmed and/or otherwise needing confirmation. Subsequently, one or more digital representations of one or more biometrics and/or other identifiers may be received for the person via one or more second electronic devices. The person may be identified using the one or more digital representations of the one or more biometrics and/or other identifiers and it may be determined that the record for the person is noted as unconfirmed and/or otherwise needing confirmation. In response, one or more confirmation processes may be initiated. For example, confirmation may be requested from a live agent associated with the one or more second electronic devices. Upon receipt of such confirmation, the record for the person may be updated.

In various embodiments, a system includes a non-transitory storage medium that stores instructions and a processor. The processor executes the instructions to receive information for a person from at least one first electronic device; receive biometric data for the person from the at least one first electronic device; verify an identity of the person using the information; note in a record for the person that biometric identity system registration for the person is unconfirmed; identify the person using at least one identifier received from at least one second electronic device; and upon determining from the record that the biometric identity system registration for the person is unconfirmed, initiate a confirmation procedure to confirm the biometric identity system registration for the person.

In some examples, the information is obtained from an identification token associated with the person. In a number of examples, the processor verifies the identity of the person by comparing the information to data associated with an identification token. In various examples, the processor verifies the identity of the person by comparing the information to data obtained by electronically communicating with an identification token. In some examples, the processor verifies the identity of the person by comparing the information to data obtained by electronically communicating with a data store associated with issuance of an identification token.

In various examples, the processor verifies the identity of the person by attempting to perform a first verification procedure, determining that the first verification procedure was unsuccessful, and performing a second verification procedure. In a number of implementations of such examples, the second verification procedure is a knowledge-based authentication quiz.

In some embodiments, a system includes a non-transitory storage medium that stores instructions and a processor. The processor executes the instructions to identify a person using at least one identifier for the person from at least one electronic device; upon determining from a record associated with a biometric identity system registration for the person that the biometric identity system registration for the person is confirmed, perform an action using identity information associated with the person; and upon determining from the record that the biometric identity system registration for the person is unconfirmed, initiate a confirmation procedure to confirm the biometric identity system registration for the person.

In a number of examples, the at least one identifier is at least one digital representation of a biometric for the person. In various implementations of such examples, the at least one digital representation of the biometric for the person is at least a portion of a face.

In some examples, the at least one identifier is a barcode. In a number of implementations of such examples, the barcode is a quick response code. In various implementations of such examples, the processor provides the barcode to another electronic device associated with the person. In some implementations of such examples, the processor provides the barcode in response to an initial biometric identity system registration of the person.

In a number of embodiments, a system includes a non-transitory storage medium that stores instructions and a processor. The processor executes the instructions to receive at least one digital representation of a biometric for a person from at least one electronic device; identify the person by comparing the digital representation of the biometric for the person to biometric data for multiple people associated with identity information for the multiple people; upon determining from a record associated with a biometric identity system registration for the person that the biometric identity system registration for the person is confirmed, perform an action using respective identity information associated with the person; and upon determining from the record that the biometric identity system registration for the person is unconfirmed, initiate a confirmation procedure to confirm the biometric identity system registration for the person.

In various examples, the confirmation procedure includes requesting an agent associated with the at least one electronic device confirm the biometric identity system registration for the person. In some implementations of such examples, the processor updates the record that the biometric identity system registration for the person is confirmed upon receiving confirmation from the agent. In a number of implementations of such examples, the at least one electronic device is an enrollment station. In various implementations of such examples, the confirmation from the agent is received from the enrollment station. In some implementations of such examples, the confirmation from the agent is received from another electronic device associated with the enrollment station.

### BRIEF DESCRIPTION OF THE DRAWINGS

The disclosure will be readily understood by the following detailed description in conjunction with the accompanying drawings, wherein like reference numerals designate like structural elements.

FIG. 1 depicts an example system for distributed biometric identity system enrollment with live confirmation.

FIG. 2 is a flow chart illustrating a first example method for distributed biometric identity system enrollment with live confirmation. The method may be performed by the system of FIG. 1.

FIG. 3 is a flow chart illustrating a first example method for distributed biometric identity system enrollment with live confirmation. The method may be performed by the system of FIG. 1.

FIG. 4 depicts example relationships among example components that may be used to implement the system of FIG. 1.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, apparatuses, methods, and computer program products that embody various elements of the present disclosure. However, it should be understood that the described disclosure may be practiced in a variety of forms in addition to those described herein.

Enrollment in a biometric identity system may include receiving biographic (such as one or more names, addresses, identification card numbers and/or other identifiers, and so on) and/or other identity information for a person, verifying the identity of the person (such as one or more knowledge-based authentication quizzes using information obtained for the person from one or more databases using the biographic and/or other identity information for the person), obtaining biometric data (such as one or more digital representations of one or more biometrics) for the person, and storing the biographic and/or other identity information for the person in association with the biometric data. The identity information may include various payment data, which may be obtained from the person in order to cover any charge for the person's participation in the biometric identity system, be used for any kind of biometric payments, and so on.

Typically, enrollment in a biometric identity system is performed at an enrollment station that is monitored by a live agent. This may ensure that the person who provides the biometric data is the same person as the one who corresponds to the biographic and/or other identity information.

For example, such an enrollment station may be located at a location where security and/or other identification screening is used, such as at an airport, event venue, and so on. The enrollment station may be positioned outside of a security and/or other identification lane where a security and/or other identification station may be located. People who are already enrolled in a biometric identity system associated with the enrollment station and/or the security and/or other identification station may proceed to the security and/or other identification station for identification. However, people who are not enrolled in the biometric identity system may first use the enrollment station prior to proceeding to the security and/or other identification station for identification.

However, one of the most significant limitations on the enrollment station, and/or enrollment in the biometric identity system in general, may be the throughput capacity of the enrollment station. Quite simply, an enrollment station may only be capable of enrolling a particular number of people in the biometric identity system in a given amount of time. The enrollment process for each person may require a given amount of time, only a fixed number of enrollment stations may be available for use, and the number of people attempting to enroll in the biometric identity system may simply exceed the available capacity.

Another option would be to allow people to enroll in the biometric identity system from one or more unmonitored devices, such as via an app associated with the biometric identity system executing on a mobile computing device; a web browser executing on a laptop computing device, desktop computing device, mobile computing device, tablet computing device, personal electronic device associated with the person, or the like; and so on. However, it may be challenging to ensure that the person who provides the biometric data is the same person as the one who corresponds to the biographic and/or other identity information when allowing enrollment from unmonitored devices. Techniques may be available to ensure that the biometric data is at least provided from a live person (such as by capturing facial, retina, iris, and/or other data from a moving video; measuring iris dilation response to one or more colored lights while capturing facial, retina, iris, and/or other data; detecting body temperature while capturing one or more fingerprints, thumbprints, palmprints, and so on; or the like). However, even though it may be determined that the biometric data is at least provided from a live person, that live person may not be the same person as the one who corresponds to the biographic and/or other identity information. As such, the identity information stored by such a biometric identity system may not be as reliable as those stored by a biometric identity system that monitors collection of the biometric data.

The present disclosure relates to distributed biometric identity system enrollment with live confirmation. Biographic and/or other identity information may be obtained for a person via one or more first electronic devices. Biometric data may also be obtained for the person via the one or more first electronic devices. The biographic and/or other identity information may be used to verify the identity of the person. The person may then be enrolled in a biometric identity system, but a record for the person may be noted as unconfirmed and/or otherwise needing confirmation. Subsequently, one or more digital representations of one or more biometrics and/or other identifiers may be received for the person via one or more second electronic devices. The person may be identified using the one or more digital representations of the one or more biometrics and/or other identifiers and it may be determined that the record for the person is noted as unconfirmed and/or otherwise needing confirmation. In response, one or more confirmation processes may be initiated. For example, confirmation may be requested from a live agent associated with the one or more second electronic devices. Upon receipt of such confirmation, the record for the person may be updated.

In this way, the operation of the monitored electronic devices and/or the biometric identity systems including such may be improved as the enrollment throughput and/or capacity and/or response time is improved while still ensuring that the person who provides the biometric data is the same person as the one who corresponds to the biographic and/or other identity information. The monitored electronic devices may be able to enroll more people in less time while using fewer hardware and/or software resources. This may allow performance of functions that were previously not performable and enables more efficiency while expending less work, eliminating unnecessary hardware and/or other components, and more efficiently using hardware, software, network, and/or other resources. This may improve the operation of systems involved by reducing unnecessary components, increasing the speed at which the systems perform operations, and/or reducing consumption of hardware, software, network, and/or other resources.

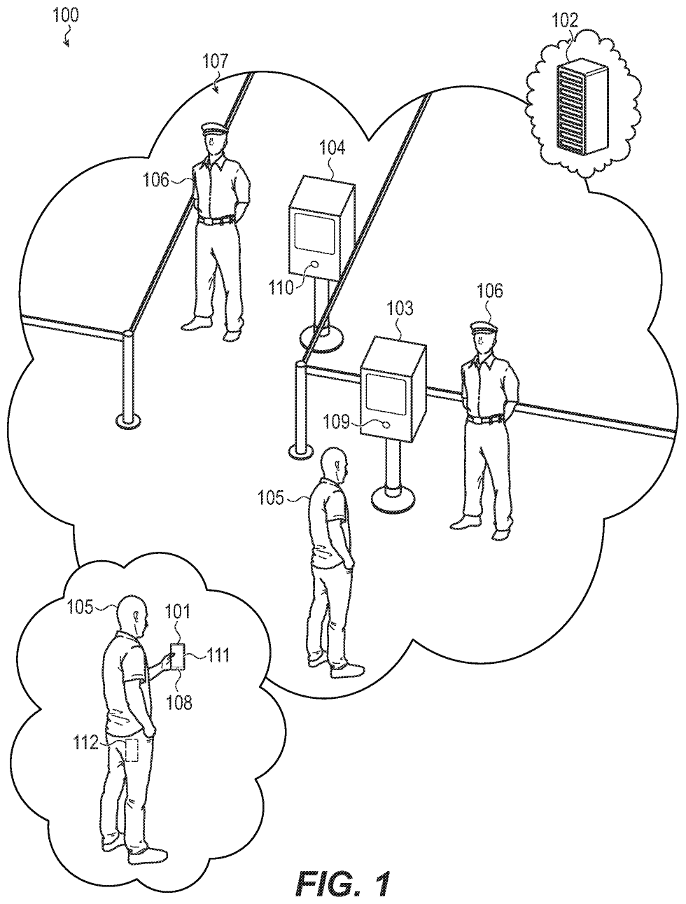

These and other embodiments are discussed below with reference to FIGS. 1-4. However, those skilled in the art will readily appreciate that the detailed description given herein with respect to these Figures is for explanatory purposes only and should not be construed as limiting.

FIG. 1 depicts an example system 100 for distributed biometric identity system enrollment with live confirmation. The system 100 may obtain biographic and/or other identity information for a person 105 via one or more first electronic devices. The system 100 may also obtain biometric data for the person 105 via the one or more first electronic devices. The system 100 may use the biographic and/or other identity information to verify the identity of the person 105. The system 100 may then enroll the person 105 in a biometric identity system, but may note a record for the person 105 as unconfirmed and/or otherwise needing confirmation. Subsequently, the system 100 may receive one or more digital representations of one or more biometrics and/or other identifiers for the person 105 via one or more second electronic devices. The system 100 may identify the person 105 using the one or more digital representations of the one or more biometrics and/or other identifiers and the system 100 may determine that the record for the person 105 is noted as unconfirmed and/or otherwise needing confirmation. In response, the system 100 may initiate one or more confirmation procedures. For example, the system 100 may request confirmation from a live agent 106 associated with the one or more second electronic devices. The live agent 106 may compare the person 105 to displayed stored biometric data for the person 105 to confirm that that person is the same person 105 who provided the biometric data. Upon receipt of such confirmation, the system 100 may update the record for the person's registration.

In this way, the operation of the system 100 and/or the devices involved therein may be improved as the enrollment throughput and/or capacity is increased while the response time is reduced and while still ensuring that the person 105 who provides the biometric data is the same person 105 as the one who corresponds to the biographic and/or other identity information. For example, full registration at a monitored device may take 5 or 6 minutes whereas confirmation of a previously completed registration at a monitored device may take less than a minute. The monitored electronic devices may be able to enroll more people 105 in less time while using fewer hardware and/or software resources. This may allow performance of functions that were previously not performable and enables more efficiency while expending less work, eliminating unnecessary hardware and/or other components, and more efficiently using hardware, software, network, and/or other resources. This may improve the operation of the system 100 by reducing unnecessary components, increasing the speed at which the systems perform operations, and/or reducing consumption of hardware, software, network, and/or other resources.

The system 100 may include one or more user electronic devices 101, identity system devices 102, enrollment stations 103, security stations 104 and/or other identification stations, and so on. The enrollment station 103 may be located at a location 107 outside of a security screening and/or other kind of identification lane where one or more security stations 104 and/or other identifications are located. A person 105 may communicate with the identity system device 102 via the user electronic device 101 to perform an initial biometric identity system registration process.

For example, the identity system device 102 may receive biographic and/or other identity information for the person 105 from the user electronic device 101. The user electronic device 101 may receive the biographic and/or other identity information from the person 105 via one or more input and/or output devices (such as a touch screen 111, one or more keyboards, computer mice, and so on). Alternatively and/or additionally, the user electronic device 101 may receive the biographic and/or other identity information electronically from one or more identification tokens 112 associated with the person 105, such as one or more driver's licenses, state and/or federal identifications, passports, and so on. By way of example, the user electronic device 101 may use a camera 108 and/or other image sensor to obtain one or more images of the identification token 112 and process the one or more images to obtain biographic and/or other identity information depicted on the identification token 112. By way of another example, the user electronic device 101 may use a communication component to communicate with a communication component of the identification token 112, such as using near field communication to communicate with a near field communication chip included in a passport or identity card.

The identity system device 102 may also obtain biometric data for the person 105 via the user electronic device 101. For example, the user electronic device 101 may use a camera 108 and/or other image sensor and/or other sensor to obtain one or more images of at least a portion of the face of the person 105, an iris of the person 105, a retina of the person 105, at least a portion of one or more fingerprints of the person 105, at least a portion of one or more thumbprints of the person 105, at least a portion of one or more palmprints of the person 105, at least a portion of one or more palm vein-scans of the person 105, and/or other biometric data

The biographic and/or other identity information may be used to verify the identity of the person 105. For example, biographic and/or other identity information entered by the person 105 may be compared to biographic and/or other identity information scanned from the identification token 112, obtained by electronically communicating with the identification token 112 (such as via one or more communication units included in the user electronic device 101 and/or the identification token 112), and so on. By way of another example, biographic and/or other identity information entered by the person 105 and/or obtained from the identification token 112 may be compared with a data store associated with issuance of the identification token 112 (such as an American Association of Motor Vehicle Administrator database that may be used to verify information from a driver's license). In still another example, biographic and/or other identity information may be used to obtain information for the person 105 from one or more databases and/or data stores that may be used to perform one or more knowledge-based authentication quizzes to verify the identity of the person 105. In yet other examples, a first verification procedure may be attempted (such as comparing biographic and/or other identity information entered by the person 105 to biographic and/or other identity information obtained by electronically communicating with the identification token 112 and/or a data store associated with issuance of the identification token 112) and a second verification procedure (such as one or more knowledge-based authentication quizzes) may be performed if the first verification procedure is determined to be unsuccessful and/or does not verify the person's identity within a threshold fidelity level.

Knowledge-based authentication quizzes may require more time than the other verification methods mentioned above. Additionally, information needed for knowledge-based authentication quizzes may not be available for all people. Thus, use of the other verification methods above as opposed to knowledge-based authentication quizzes (and/or as a first verification procedure where the knowledge-based authentication quizzes are a second verification procedure) may improve response time over knowledge-based authentication quizzes and/or increase the number of people who may be enrolled in the biometric identity system.

The identification token 112 is shown as a physical token. However, it is understood that this is an example. In some implementations, the identification token 112 may be digital, such as a mobile driver's license stored by the user electronic device 101 and/or another electronic device that the user electronic device is configured to communicate with. Various configurations are possible and contemplated without departing from the scope of the present disclosure.

After verification of the person's identity, the identity system device 102 may enroll the person 105 in a biometric identity system, such as a system associated with the identity system device 102. However, the identity system device 102 may note a record for the person 105 as unconfirmed and/or otherwise needing confirmation. Such a record may be included in and/or associated with the identity information for the person 105.

Although this initial registration of the person 105 in the biometric identity system is described above in the context of particular procedures, it is understood that this is an example. Other configurations of the same, different, and/or similar procedures may be used without departing from the scope of the present disclosure.

For example, this initial registration of the person 105 in the biometric identity system may include one or more other procedures. By way of illustration, the identity system device 102 may obtain payment data (such as one or more credit card and/or debit card numbers, bank account numbers, checking account numbers, data from one or more mobile payments received and/or otherwise configured via the user electronic device 101, and so on) for the person 105. The identity system device 102 may use the payment data in order to cover any charge for the person's participation in the biometric identity system, be used for any kind of biometric payments, and so on. Such payment data may be included in and/or associated with the identity information for the person 105.

By way of another illustration the identity system device 102 may store identity information for the person 105. The identity information may include and/or be associated with biometric data for the person 105, the biographic information, payment data, and so on.

Subsequently, the identity system device 102 may receive one or more digital representations of one or more biometrics and/or other identifiers (such as one or more bar codes, quick response codes, and so on) for the person 105, such as via a camera 109 and/or other sensor of the enrollment station 103, a camera 110 and/or other sensor of the security station 104, and so on. For example, after the initial registration of the person 105 in the biometric identity system, the identity system device 102 may transmit the identifier to the user electronic device 101 with a prompt for the user to go to the enrollment station 103, the security station 104, and/or another device to confirm the person's registration.

The identity system device 102 may identify the person 105 using the one or more digital representations of the one or more biometrics and/or other identifiers. The identity system device 102 may compare the one or more digital representations of the one or more biometrics and/or other identifiers for the person 105 to biometric data and/or identifiers associated with multiple people. The biometric data and/or identifiers associated with multiple people may be associated with identity information for the multiple people.

From this identification, the identity system device 102 may determine that the record for the person 105 is noted as unconfirmed and/or otherwise needing confirmation. In response, the identity system device 102 may request confirmation from a live agent 106 associated with the enrollment station 103, the security station 104, and/or another device (such as via the enrollment station 103, the security station 104, and/or another device, via another device associated with the live agent 106, and so on).

The identity system device 102 may receive confirmation from the live agent 106. The identity system device 102 may receive such confirmation from the enrollment station 103, the security station 104, and/or another device associated with the live agent 106. Upon receipt of such confirmation, the record for the person 105 may be updated.

Although the above describes a number of functions of the system 100 as performed by the identity system device 102, it is understood that this is an example. In other implementations it may be performed by one or more of the user electronic device 101, the enrollment station 103, the security station 104, and/or another device. Various configurations are possible and contemplated without departing from the scope of the present disclosure.

Although the above illustrates and describes the confirmation procedure as including the system 100 requesting confirmation from a live agent 106 associated with the one or more second electronic devices, it is understood that this is an example. In other examples, the confirmation procedure may include the system 100 verifying that the person is in possession of a device associated with the identity, such as by tapping a smart phone associated with the identity to initiate a near-field communication connection with the smart phone. In still other examples, the confirmation procedure may include the system 100 scanning and/or otherwise communicating with an identification token associated with the identity. Various configurations are possible and contemplated without departing from the scope of the present disclosure.

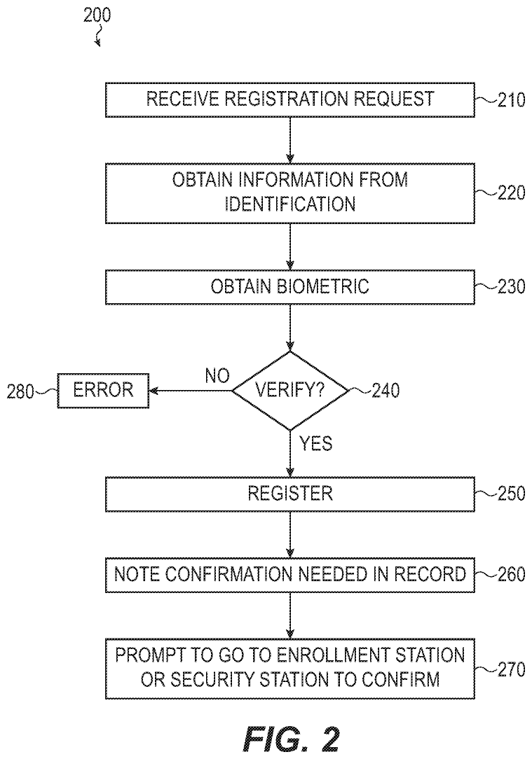

FIG. 2 is a flow chart illustrating a first example method 200 for distributed biometric identity system enrollment with live confirmation. The method 200 may be performed by the system 100 of FIG. 1.

At operation 210, an electronic device (such as the identity system device 102, the user electronic device 101, the enrollment station 103, and/or the security station 104 of FIG. 1) may receive a registration request. The registration request may be a request to register a person in a biometric identity system. The registration request may be received via a user electronic device.

At operation 220, the electronic device may obtain information for the person from one or more identifications associated with the person, such as one or more physical and/or digital identification tokens like one or more driver's licenses, state and/or federal identifications, passports, and so on. The information may include biographic information and/or identity information for the person.

At operation 230, one or more digital representations of one or more biometrics (such as one or more fingerprints, blood vessel scans, palm-vein scans, voiceprints, facial images, retina images, iris images, deoxyribonucleic acid sequences, heart rhythms, gaits, and so on) may be obtained for the person. The one or more digital representations of the one or more biometrics may be obtained via one or more biometric reader devices (such as one or more fingerprint scanners, a blood vessel scanner, a palm-vein scanner, an optical fingerprint scanner, a phosphorescent fingerprint scanner, a still image and/or video camera, a 2D and/or 3D image sensor, a capacitive sensor, a saliva sensor, a deoxyribonucleic acid sensor, a heart rhythm monitor, a microphone, and so on).

At operation 240, the electronic device may determine whether or not the electronic device can verify the identity of the person. The electronic device may use the information to verify the identity of the person. If not, the flow may proceed to operation 280 where the electronic device determines that an error has occurred. Otherwise, the flow may proceed to operation 250 where the electronic device registers the person in the biometric identity system.

For example, biographic and/or other identity information entered by the person may be compared to biographic and/or other identity information scanned from an identification token, obtained by electronically communicating with the identification token, and so on. By way of another example, biographic and/or other identity information entered by the person and/or obtained from an identification token may be compared with a data store associated with issuance of the identification token (such as an American Association of Motor Vehicle Administrator database that may be used to verify information from a driver's license). In still another example, biographic and/or other identity information may be used to obtain information for the person from one or more databases and/or data stores that may be used to perform one or more knowledge-based authentication quizzes to verify the identity of the person. In yet other examples, a first verification procedure may be attempted (such as comparing biographic and/or other identity information entered by the person to biographic and/or other identity information obtained by electronically communicating with an identification token and/or a data store associated with issuance of the identification token) and a second verification procedure (such as one or more knowledge-based authentication quizzes) may be performed if the first verification procedure is determined to be unsuccessful and/or does not verify the person's identity within a threshold fidelity level. Various configurations are possible and contemplated without departing from the scope of the present disclosure.

After the electronic device registers the person in the biometric identity system at operation 250, the flow may proceed to operation 260 where the electronic device may note that confirmation is needed in a record associated with the person. The flow may then proceed to operation 270 where the electronic device may prompt the person to go to an enrollment station, a security station, and/or other identification station to confirm.

In various examples, this example method 200 may be implemented using a group of interrelated software modules or components that perform various functions discussed herein. These software modules or components may be executed within a cloud network and/or by one or more computing devices, such as the identity system device 102, the user electronic device 101, the enrollment station 103, and/or the security station 104 of FIG. 1.

Although the example method 200 is illustrated and described as including particular operations performed in a particular order, it is understood that this is an example. In various implementations, various orders of the same, similar, and/or different operations may be performed without departing from the scope of the present disclosure.

For example, the method 200 is illustrated and described as receiving the information from the identification. However, it is understood that this is an example. In some implementations, the electronic device may receive the information from the person via the user electronic device. Various configurations are possible and contemplated without departing from the scope of the present disclosure.

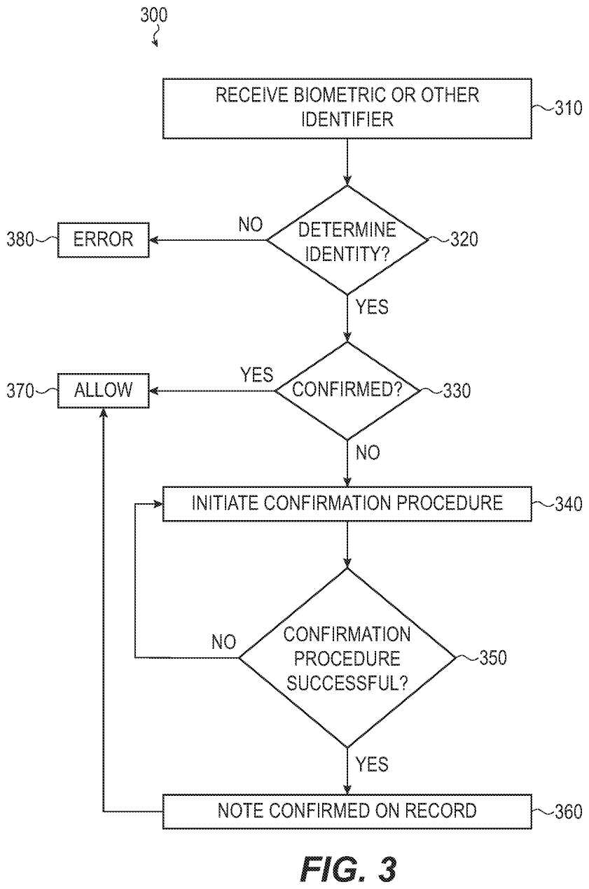

FIG. 3 is a flow chart illustrating a first example method 300 for distributed biometric identity system enrollment with live confirmation. The method 300 may be performed by the system 100 of FIG. 1.

At operation 310, an electronic device (such as the identity system device 102, the user electronic device 101, the enrollment station 103, and/or the security station 104 of FIG. 1) may receive one or more digital representations of one or more biometrics and/or other identifiers for a person. For example, the electronic device may receive the one or more digital representations of the one or more biometrics and/or other identifiers for the person via one or more cameras and/or other sensors.

At operation 320, the electronic device may determine whether or not the electronic device can use the one or more digital representations of the one or more biometrics and/or other identifiers to identify the person. If not, the flow may proceed to operation 380 where the electronic device determines that an error has occurred. Otherwise, the flow may proceed to operation 330.

For example, the electronic device may compare the one or more digital representations of the one or more biometrics and/or other identifiers for the person to biometric data and/or identifiers associated with multiple people. The biometric data and/or identifiers associated with multiple people may be associated with identity information for the multiple people.

At operation 330, after the electronic device may determine that the electronic device can use the one or more digital representations of the one or more biometrics and/or other identifiers to identify the person, the electronic device may determine whether or not a record associated with the person, identity information for the person, and so on indicates that the person's registration is unconfirmed. If no, the flow may proceed to operation 370 where the electronic device allows the person access and/or performs one or more actions, such as one or more actions using and/or related to identity information stored for the person. Otherwise, the flow may proceed to operation 340.

At operation 340, after the electronic device determines that a record associated with the person, identity information for the person, and so on indicates that the person's registration is unconfirmed, the electronic device may initiate a confirmation procedure.

In some examples, the confirmation procedure may including requesting confirmation from an agent associated with the electronic device. In other examples, the confirmation procedure may include verifying that the person is in possession of a device associated with the identity, such as by tapping a smart phone associated with the identity to initiate a near-field and/or other communication connection with the smart phone. In still other examples, the confirmation procedure may include scanning and/or otherwise communicating with an identification token associated with the identity. Various configurations are possible and contemplated without departing from the scope of the present disclosure.

At operation 350, the electronic device may determine whether or not the confirmation procedure is successful. For example, in implementations where the confirmation procedure includes requesting confirmation from an agent associated with the electronic device, determining whether or not the confirmation procedure is successful may include determining whether or not confirmation is received. If not, the flow may return to operation 340 where the electronic device may again initiate the confirmation procedure. Otherwise, the flow may proceed to operation 360 where the electronic device may note that the person's registration is now confirmed in the record.

The flow may then proceed to operation 370 where the electronic device allows the person access and/or performs one or more actions, such as one or more actions using and/or related to identity information stored for the person

In various examples, this example method 300 may be implemented using a group of interrelated software modules or components that perform various functions discussed herein. These software modules or components may be executed within a cloud network and/or by one or more computing devices, such as the identity system device 102, the user electronic device 101, the enrollment station 103, and/or the security station 104 of FIG. 1.

Although the example method 300 is illustrated and described as including particular operations performed in a particular order, it is understood that this is an example. In various implementations, various orders of the same, similar, and/or different operations may be performed without departing from the scope of the present disclosure.

For example, the method is illustrated and described as returning to operation 340 if confirmation is not received. However, it is understood that this is an example. In some implementations, the flow may instead proceed to operation 380 where the electronic device may determine that an error has occurred. Various configurations are possible and contemplated without departing from the scope of the present disclosure.

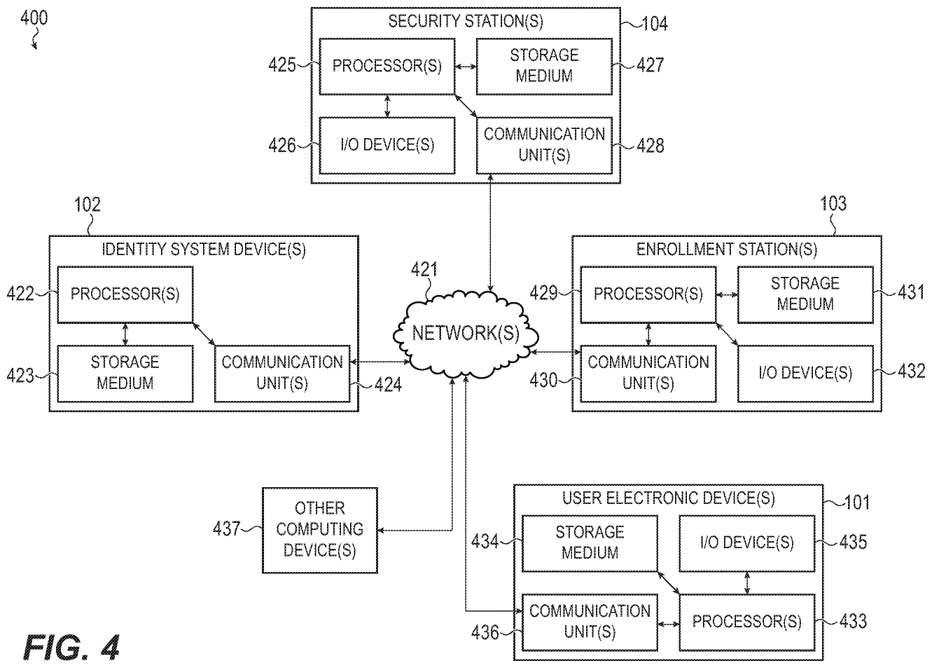

FIG. 4 depicts example relationships 400 among example components that may be used to implement the system 100 of FIG. 1. As shown, one or more of the identity system device 102, the security station 104, the enrollment station 103, the user electronic device 101, one or more other computing devices 437 (such as one or more databases or data stores that may be used to obtain information for a person to use for one or more knowledge-based authentication quizzes, one or more databases or data associated with issuance of an identification token (such as an American Association of Motor Vehicle Administrator database that may be used to verify information from a driver's license)), and/or one or more other devices may be operable to communicate with each other via one or more wired and/or wireless networks 421.

The identity system device 102 may store identity information (such as one or more names, addresses, telephone numbers, social security numbers, patient identification numbers or other identifiers, insurance data, financial data, health information (such as one or more temperatures, pupil dilation, medical diagnoses, immunocompromised conditions, medical histories, medical records, infection statuses, vaccinations, immunology data, results of antibody tests evidencing that a person has had a particular communicable illness and recovered, blood test results, saliva test results, and/or the like), and so on) associated with the identities of people (which may be verified identities, where the identities are verified as corresponding to the particular person named and/or where the identity information is verified as valid). Alternatively and/or additionally, some or all of the health information may be stored separately from the identity information but otherwise associated with the identity information, such as in a Health Insurance Portability and Accountability Act (“HIPAA”) compliant or other data store or enclave. Such a data store or enclave may be stored on one or more different storage media than the identity information, or may be stored on the same storage medium or media and logically isolated from the identity information. The health information may be simultaneously and/or substantially simultaneously accessible as the identity information, such as where the identity information includes a health information identifier or key that may be used to access the separately stored health information. The identity system device 102 may control access to the identity information and/or the health information using identity information that is associated with the identity information. The identity information may include biometric data (which may include one or more digital representations of one or more fingerprints, blood vessel scans, palm-vein scans, voiceprints, facial images, retina images, iris images, deoxyribonucleic acid sequences, heart rhythms, gaits, and so on), one or more logins and/or passwords, authorization tokens, social media and/or other accounts, and so on. In various implementations, the identity system device 102 may allow the person associated with an identity to control access to the identity information, the health information, and/or other information (such as payment account information, health information (such as medical records, HIPAA protected information in order to be compliant with various legal restrictions, and so on), contact information, and so on. The identity system device may control access to such information according to input received from the person. The identity system device 102 may be operable to communicate with one or more other devices in order to handle requests to provide the identity information and/or the health information, update and/or otherwise add to the identity information and/or the health information, provide attestations regarding and/or related to the identity information and/or the health information (such as whether or not a person is of a particular age, whether or not a person has a particular license or insurance policy, whether or not a person has been monitored as having particular health information, whether or not a person has had a particular vaccination, whether or not an antibody test evidences that a person has had a particular communicable illness and recovered, whether or not a person has a particular ticket or authorization, whether or not a person has been monitored as having particular antibodies, whether or not a person has been assigned a particular medical diagnosis, and so on), evaluate health information stored in the identity information and/or otherwise associated with the identity information and/or other information stored in the identity information, perform transactions, allow or deny access, route one or more persons, and/or perform one or more other actions.

The identity system device 102 may be any kind of electronic device and/or cloud and/or other computing arrangement. Examples of such devices include, but are not limited to, one or more desktop computing devices, laptop computing devices, mobile computing devices, wearable devices, tablet computing devices, mobile telephones, kiosks and/or other stations, smart phones, printers, displays, vehicles, kitchen appliances, entertainment system devices, digital media players, and so on. The identity system device 102 may include one or more processors 422 and/or other processing units or controllers, communication units 424 (such as one or more network adapters and/or other devices used by a device to communicate with one or more other devices), non-transitory storage media 423, and/or other components. The processor 422 may execute one or more sets of instructions stored in the non-transitory storage media 423 to perform various functions, such as receiving and/or storing biometric data and/or other identity information, receiving and/or storing identity information and/or health information, matching one or more received digital representations of biometrics and/or other identity information to stored data, retrieving identity information and/or health information associated with stored data matching one or more received digital representations of biometrics and/or other identity information, providing retrieved identity information and/or health information, communicating with one or more other devices via the network 421 using the communication unit 424, and so on. Alternatively and/or additionally, the identity system device 102 may involve one or more memory allocations configured to store at least one executable asset and one or more processor allocations configured to access the one or more memory allocations and execute the at least one executable asset to instantiate one or more processes and/or services, such as one or more gallery management services, biometric identifications services, and so on.

Similarly, the user electronic device 101 may be any kind of device. The user electronic device 101 may include one or more processors 433 and/or other processing units and/or controllers, one or more non-transitory storage media 434 (which may take the form of, but is not limited to, a magnetic storage medium; optical storage medium; magneto-optical storage medium; read only memory; random access memory; erasable programmable memory; flash memory; and so on), one or more communication units 436; one or more input and/or output devices 435 (such as one or more health sensors (such as a thermometer and/or other thermal sensor, a blood pressure sensor, a blood test sensor, a blood vessel scanner, a palm-vein scanner, a still image and/or video camera, a 2D and/or 3D image sensor, a saliva sensor, breath sensor, a deoxyribonucleic acid sensor, a heart rhythm monitor, a microphone, sweat sensors, and so on), one or more biometric readers (such as a fingerprint scanner, a blood vessel scanner, a palm-vein scanner, an optical fingerprint scanner, a phosphorescent fingerprint scanner, a still image and/or video camera, a 2D and/or 3D image sensor, a capacitive sensor, a saliva sensor, a deoxyribonucleic acid sensor, a heart rhythm monitor, a microphone, and so on), one or more touch screens, one or more displays, one or more trackpads, one or more keyboards, one or more computer mice, and so on); and/or one or more other components. The processor 433 may execute one or more sets of instructions stored in the non-transitory storage 434 media to perform various functions, such as using a biometric reader to obtain one or more digital representations of one or more biometrics (such as a digital representation of a fingerprint, a blood vessel scan, a palm-vein scan, a voiceprint, a facial image, a retina image, an iris image, a deoxyribonucleic acid sequence, a heart rhythm, a gait, and so on) for a person, obtain health information for a person using a health sensor, communicate with one or more other devices via the network 421 using the communication unit 436, and so on.

Likewise, the enrollment station 103 may be any kind of device. The enrollment station 103 may include one or more processors 429 and/or other processing units and/or controllers, one or more non-transitory storage media 431 (which may take the form of, but is not limited to, a magnetic storage medium; optical storage medium; magneto-optical storage medium; read only memory; random access memory; erasable programmable memory; flash memory; and so on), one or more communication units 430; one or more input and/or output devices 432 (such as one or more health sensors, one or more biometric readers, one or more touch screens, one or more displays, one or more trackpads, one or more keyboards, one or more computer mice, and so on); and/or one or more other components. The processor 429 may execute one or more sets of instructions stored in the non-transitory storage media 431 to perform various functions, such as using a biometric reader to obtain one or more digital representations of one or more biometrics (such as a digital representation of a fingerprint, a blood vessel scan, a palm-vein scan, a voiceprint, a facial image, a retina image, an iris image, a deoxyribonucleic acid sequence, a heart rhythm, a gait, and so on) for a person, obtain health information for a person using a health sensor, communicate with one or more other devices via the network 421 using the communication unit 430, and so on.

Additionally, the security station 104 may be any kind of device. The security station 104 may include one or more processors 425 and/or other processing units and/or controllers, one or more non-transitory storage media 427 (which may take the form of, but is not limited to, a magnetic storage medium; optical storage medium; magneto-optical storage medium; read only memory; random access memory; erasable programmable memory; flash memory; and so on), one or more communication units 428; one or more input and/or output devices 426 (such as one or more health sensors, one or more biometric readers, one or more touch screens, one or more displays, one or more trackpads, one or more keyboards, one or more computer mice, and so on); and/or one or more other components. The processor 425 may execute one or more sets of instructions stored in the non-transitory storage media 427 to perform various functions, such as using a biometric reader to obtain one or more digital representations of one or more biometrics (such as a digital representation of a fingerprint, a blood vessel scan, a palm-vein scan, a voiceprint, a facial image, a retina image, an iris image, a deoxyribonucleic acid sequence, a heart rhythm, a gait, and so on) for a person, obtain health information for a person using a health sensor, communicate with one or more other devices via the network 421 using the communication unit 428, and so on.

As used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

Example information can include, but may not be limited to: personal identity information (e.g., names, social security numbers, telephone numbers, email addresses, physical addresses, driver's license information, passport numbers, and so on); identity documents (e.g., driver's licenses, passports, government identification cards or credentials, and so on); protected health information (e.g., medical records, dental records, and so on); financial, banking, credit, or debt information; third-party service account information (e.g., usernames, passwords, social media handles, and so on); encrypted or unencrypted files; database files; network connection logs; shell history; filesystem files; libraries, frameworks, and binaries; registry entries; settings files; executing processes; hardware vendors, versions, and/or information associated with the compromised computing resource; installed applications or services; password hashes; idle time, uptime, and/or last login time; document files; product renderings; presentation files; image files; customer information; configuration files; passwords; and so on. It may be appreciated that the foregoing examples are not exhaustive.

The foregoing examples and description of instances of purpose-configured software, whether accessible via API as a request-response service, an event-driven service, or whether configured as a self-contained data processing service, are understood as not exhaustive. In other words, a person of skill in the art may appreciate that the various functions and operations of a system such as described herein can be implemented in a number of suitable ways, developed leveraging any number of suitable libraries, frameworks, first- or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

In various implementations, a system may include a non-transitory storage medium that stores instructions and a processor. The processor may execute the instructions to receive information for a person from at least one first electronic device; receive biometric data for the person from the at least one first electronic device; verify an identity of the person using the information; note in a record for the person that biometric identity system registration for the person is unconfirmed; identify the person using at least one identifier received from at least one second electronic device; and upon determining from the record that the biometric identity system registration for the person is unconfirmed, initiate a confirmation procedure to confirm the biometric identity system registration for the person.

In some examples, the information may be obtained from an identification token associated with the person. In a number of examples, the processor may verify the identity of the person by comparing the information to data associated with an identification token. In various examples, the processor may verify the identity of the person by comparing the information to data obtained by electronically communicating with an identification token. In some examples, the processor may verify the identity of the person by comparing the information to data obtained by electronically communicating with a data store associated with issuance of an identification token.

In various examples, the processor may verify the identity of the person by attempting to perform a first verification procedure, determining that the first verification procedure was unsuccessful, and performing a second verification procedure. In a number of such examples, the second verification procedure may be a knowledge-based authentication quiz.

In some implementations, a system may include a non-transitory storage medium that stores instructions and a processor. The processor may execute the instructions to identify a person using at least one identifier for the person from at least one electronic device; upon determining from a record associated with a biometric identity system registration for the person that the biometric identity system registration for the person is confirmed, perform an action using identity information associated with the person; and upon determining from the record that the biometric identity system registration for the person is unconfirmed, initiate a confirmation procedure to confirm the biometric identity system registration for the person.

In a number of examples, the at least one identifier may be at least one digital representation of a biometric for the person. In various such examples, the at least one digital representation of the biometric for the person may be at least a portion of a face.

In some examples, the at least one identifier may be a barcode. In a number of such examples, the barcode may be a quick response code. In various such examples, the processor may provide the barcode to another electronic device associated with the person. In some such examples, the processor may provide the barcode in response to an initial biometric identity system registration of the person.

In a number of implementations, a system may include a non-transitory storage medium that stores instructions and a processor. The processor may execute the instructions to receive at least one digital representation of a biometric for a person from at least one electronic device; identify the person by comparing the digital representation of the biometric for the person to biometric data for multiple people associated with identity information for the multiple people; upon determining from a record associated with a biometric identity system registration for the person that the biometric identity system registration for the person is confirmed, perform an action using respective identity information associated with the person; and upon determining from the record that the biometric identity system registration for the person is unconfirmed, initiate a confirmation procedure to confirm the biometric identity system registration for the person.

In various examples, the confirmation procedure may include requesting an agent associated with the at least one electronic device confirm the biometric identity system registration for the person. In some such examples, the processor may update the record that the biometric identity system registration for the person is confirmed upon receiving confirmation from the agent. In a number of such examples, the at least one electronic device may be an enrollment station. In various such examples, the confirmation from the agent may be received from the enrollment station. In some such examples, the confirmation from the agent may be received from another electronic device associated with the enrollment station. Although the above illustrates and describes a number of embodiments, it is understood that these are examples. In various implementations, various techniques of individual embodiments may be combined without departing from the scope of the present disclosure.

As described above and illustrated in the accompanying figures, the present disclosure relates to distributed biometric identity system enrollment with live confirmation. Biographic and/or other identity information may be obtained for a person via one or more first electronic devices. Biometric data may also be obtained for the person via the one or more first electronic devices. The biographic and/or other identity information may be used to verify the identity of the person. The person may then be enrolled in a biometric identity system, but a record for the person may be noted as unconfirmed and/or otherwise needing confirmation. Subsequently, one or more digital representations of one or more biometrics and/or other identifiers may be received for the person via one or more second electronic devices. The person may be identified using the one or more digital representations of the one or more biometrics and/or other identifiers and it may be determined that the record for the person is noted as unconfirmed and/or otherwise needing confirmation. In response, one or more confirmation processes may be initiated. For example, confirmation may be requested from a live agent associated with the one or more second electronic devices. Upon receipt of such confirmation, the record for the person may be updated.

The present disclosure recognizes that biometric and/or other personal data is owned by the person from whom such biometric and/or other personal data is derived. This data can be used to the benefit of those people. For example, biometric data may be used to conveniently and reliably identify and/or authenticate the identity of people, access securely stored financial and/or other information associated with the biometric data, and so on. This may allow people to avoid repeatedly providing physical identification and/or other information.

The present disclosure further recognizes that the entities who collect, analyze, store, and/or otherwise use such biometric and/or other personal data should comply with well-established privacy policies and/or privacy practices. Particularly, such entities should implement and consistently use privacy policies and practices that are generally recognized as meeting or exceeding industry or governmental requirements for maintaining security and privately maintaining biometric and/or other personal data, including the use of encryption and security methods that meets or exceeds industry or government standards. For example, biometric and/or other personal data should be collected for legitimate and reasonable uses and not shared or sold outside of those legitimate uses. Further, such collection should occur only after receiving the informed consent. Additionally, such entities should take any needed steps for safeguarding and securing access to such biometric and/or other personal data and ensuring that others with access to the biometric and/or other personal data adhere to the same privacy policies and practices. Further, such entities should certify their adherence to widely accepted privacy policies and practices by subjecting themselves to appropriate third party evaluation.

Additionally, the present disclosure recognizes that people may block the use of, storage of, and/or access to biometric and/or other personal data. Entities who typically collect, analyze, store, and/or otherwise use such biometric and/or other personal data should implement and consistently prevent any collection, analysis, storage, and/or other use of any biometric and/or other personal data blocked by the person from whom such biometric and/or other personal data is derived.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A system, comprising:
a non-transitory storage medium that stores instructions; and
a processor that executes the instructions to:
receive information for a person from at least one first electronic device;
receive biometric data for the person from the at least one first electronic device;
verify an identity of the person using the information;
note in a record for the person that biometric identity system registration for the person is unconfirmed;
identify the person using at least one identifier received from at least one second electronic device; and
upon determining from the record that the biometric identity system registration for the person is unconfirmed, initiate a confirmation procedure to confirm the biometric identity system registration for the person.

2. The system of claim 1, wherein the information is obtained from an identification token associated with the person.

3. The system of claim 1, wherein the processor verifies the identity of the person by comparing the information to data associated with an identification token.

4. The system of claim 1, wherein the processor verifies the identity of the person by comparing the information to data obtained by electronically communicating with an identification token.

5. The system of claim 1, wherein the processor verifies the identity of the person by comparing the information to data obtained by electronically communicating with a data store associated with issuance of an identification token.

6. The system of claim 1, wherein the processor verifies the identity of the person by:
attempting to perform a first verification procedure;
determining that the first verification procedure was unsuccessful; and
performing a second verification procedure.

7. The system of claim 6, wherein the second verification procedure comprises a knowledge-based authentication quiz.

8. A system, comprising:
a non-transitory storage medium that stores instructions; and
a processor that executes the instructions to:
identify a person using at least one identifier for the person from at least one electronic device;
upon determining from a record associated with a biometric identity system registration for the person that the biometric identity system registration for the person is confirmed, perform an action using identity information associated with the person; and
upon determining from the record that the biometric identity system registration for the person is unconfirmed, initiating a confirmation procedure confirm the biometric identity system registration for the person.

9. The system of claim 8, wherein the at least one identifier comprises at least one digital representation of a biometric for the person.

10. The system of claim 9, wherein the at least one digital representation of the biometric for the person comprises at least a portion of a face.

11. The system of claim 8, wherein the at least one identifier comprises a barcode.

12. The system of claim 11, wherein the barcode is a quick response code.

13. The system of claim 11, wherein the processor provides the barcode to another electronic device associated with the person.

14. The system of claim 13, wherein the processor provides the barcode in response to an initial biometric identity system registration of the person.

15. A system, comprising:
a non-transitory storage medium that stores instructions; and
a processor that executes the instructions to:
receive at least one digital representation of a biometric for a person from at least one electronic device;
identify the person by comparing the digital representation of the biometric for the person to biometric data for multiple people associated with identity information for the multiple people;
upon determining from a record associated with a biometric identity system registration for the person that the biometric identity system registration for the person is confirmed, perform an action using respective identity information associated with the person; and
upon determining from the record that the biometric identity system registration for the person is unconfirmed, initiate a confirmation procedure to confirm the biometric identity system registration for the person.

16. The system of claim 15, wherein the confirmation procedure comprises requesting an agent associated with the at least one electronic device confirm the biometric identity system registration for the person.

17. The system of claim 16, wherein the processor updates the record that the biometric identity system registration for the person is confirmed upon receiving confirmation from the agent.

18. The system of claim 17, wherein the at least one electronic device comprises an enrollment station.

19. The system of claim 18, wherein the confirmation from the agent is received from the enrollment station.

20. The system of claim 18, wherein the confirmation from the agent is received from another electronic device associated with the enrollment station.
